(19) United States
(12) Patent Application Publication
(10) Pub. No.: US 2025/0256752 A1
(43) Pub. Date: Aug. 14, 2025

(54) THREE-PIECE DOLLY SYSTEM FOR PONTOONS AND OTHER VEHICLES

(71) Applicant: Caliber Products, Inc., Burnsville, MN (US)

(72) Inventors: Ernest Joseph DeLanghe, Burnsville, MN (US); Kasey L. Pipo, Burnsville, MN (US); Willaim D. Butterfield, River Falls, WI (US)

(73) Assignee: Caliber Products, Inc., Burnsville, MN (US)

(21) Appl. No.: 18/761,073

(22) Filed: Jul. 1, 2024

Related U.S. Application Data
(63) Continuation-in-part of application No. 18/439,719, filed on Feb. 12, 2024, now abandoned.

(51) Int. Cl. B62B 5/00

(52) U.S. Cl. CPC B62B 5/0083; B62B 2202/403; B62B 2202/90

(57) ABSTRACT

Embodiments are directed to systems and methods involving a dolly system for pontoon boats and wheeled vehicles. The system includes a pontoon boat or a wheeled vehicle with appropriate attachment points. Each dolly includes at least one pad with a set of attachment mechanisms. These pads are made of flexible material and can be easily removed and interchanged with other types of pads. The main types of pads work with the pontoons on the boat or the wheels on the vehicle. Each dolly has an identical base with a front, back, left, right, top, and bottom side. Each dolly has a channel, pad attachment holes, wheel attachment points, strap attachment points, and anchor points. The strategic placement of these points on the dolly base emphasizes the system's versatility, accommodating various configurations and securing the pontoon boat or wheeled vehicle during transportation or storage.

### BACKGROUND

The present disclosure is focused on dolly systems for transporting wheeled vehicles and marine pontoons. Dolly systems have found various applications. These systems provide a versatile and robust solution that is simple to set up, dismantle, and replace. However, there is still a need for a durable, long-lasting dolly system that is purpose-built for efficiently transporting wheeled vehicles and marine pontoons.

Traditional methods of moving wheeled vehicles and marine pontoons, such as manual lifting or makeshift transport solutions, can be physically demanding and risk causing damage during transit. This can result in safety concerns, equipment wear and tear, and the need for costly repairs. Additionally, these conventional methods may not be suitable for handling the constant vibrations and motion associated with transport, potentially leading to structural issues and harm to the equipment being transported.

To address these issues, a durable, long-lasting dolly system for transporting wheeled vehicles and marine pontoons has been developed. This innovative design enhances strength and durability while maintaining a lightweight and user-friendly construction, making it the ideal solution for safely and efficiently transporting large vehicles.

### SUMMARY

The present invention introduces a dolly system designed to revolutionize the transportation of wheeled vehicles and marine pontoons. Beyond its exceptional strength and durability, the dolly system prioritizes user convenience. These individual dolly modules are designed for effortless transportation and maintenance. Users can easily move the dolly modules because of their lightweight but durable body. This body may be made of a variety of materials.

Safety and stability during the transportation of wheeled vehicles and marine pontoons are paramount in our dolly system's design. The surface of each dolly module includes a specialized texture that enhances traction and prevents slippage. Moreover, the fastening straps between modules have been engineered to prevent any shifting or movement during transit, ensuring the utmost safety for both the equipment and those handling it. In some embodiments, the dolly system may be highly adaptable and tailored to meet the specific requirements of users. Modules may be customized with a variety of materials and colors to align with individual aesthetic and functional preferences.

The system may include a dolly base connected to a rubber pad with attachment mechanisms connected by holes. The system may include a dolly base featuring holes viewable from the top side. The system may include a dolly base that supports accessories such as a tie-down strap or cargo basket. The system may include a dolly base with strap attachment points and anchor points. Some embodiments include using the dolly system for snowmobiles.

The system may include a dolly system including first, second, and third pads, each with attachment mechanisms, and first, second, and third dollies with dolly bases featuring holes and attachment points. The system may include wheels and swivel casters with each pad connecting to a respective dolly base. The system may include each set of pad attachment mechanisms (first, second, and third).

### BRIEF DESCRIPTION OF THE DRAWINGS

FIG. 1 shows a top view of a dolly equipped with ski pads, wheels, and fastening straps;

FIG. 2 shows a bottom view of the dolly equipped with ski pads, wheels, and fastening straps;

FIG. 3 shows a top perspective view of the dolly equipped with ski pads, wheels, and fastening straps;

FIG. 4 shows a bottom perspective view of the dolly equipped with ski pads, wheels, and fastening straps;

FIGS. 5A-5D show the dolly equipped with ski pads, wheels, and fastening straps, showcasing the left side view, front view, right side view, and rear view, respectively;

FIG. 6 shows a top view of the dolly equipped with track pads and wheels;

FIG. 7 shows a top perspective view of the dolly equipped with track pads and wheels;

FIGS. 8A-8D show the dolly equipped with track pads and wheels, showcasing the right side view, rear view, left side view, and front view, respectively;

FIG. 9 shows a top view of the base of the dolly;

FIG. 10 shows a bottom view of the base of the dolly;

FIG. 11 shows a top perspective view of the base of the dolly;

FIG. 12 shows a bottom perspective view of the base of the dolly;

FIGS. 13A-13D show the base of the dolly, showcasing the left side view, front view, right side view, and rear view, respectively;

FIG. 14 shows multiple views of the ski pads;

FIG. 15 shows multiple views of the track pads;

FIG. 16 shows multiple views of the fastening strap;

FIG. 17 shows the dolly with a ski carbide in the channel;

FIG. 18 shows a perspective view of the ski on the dolly;

FIG. 19 shows a side view of the ski on the dolly;

FIG. 20 depicts a top view of the dolly system with removable pads designed to secure a variety of objects;

FIG. 21 depicts a side view of the same dolly system, highlighting the central channel that helps stabilize cylindrical objects;

FIG. 22 depicts the dolly system with the removable pads detached, showing the modular nature of the design;

FIG. 23 depicts the dolly system used to transport a pontoon, with pads shaped to cradle the rounded bottom of the pontoon;

FIG. 24 depicts a perspective view of the pontoon dolly system in action, with multiple dollies placed under the pontoon;

FIG. 25 depicts a rear view of the pontoon supported by the dolly system, showing the secure fit of the pads around the pontoon's float tubes;

FIG. 26 depicts the dolly system used in a full pontoon setup, showing multiple dollies in place;

FIG. 27 depicts an embodiment of the dolly system used with an ATV, showing the ATV securely positioned on the dolly system;

FIG. 28 depicts a side view of the ATV on the dolly system, emphasizing the alignment of the dollies with the ATV wheels;

FIG. 29 depicts a detailed view of the rear wheel of the ATV resting on the dolly system, highlighting the interaction between the dolly and the ATV wheel;

FIG. 30 depicts a perspective view of the front wheels of the ATV on the dolly system, illustrating the positioning of the dollies; and

FIG. 31 depicts a front view of the ATV on the dolly system, showing the alignment and positioning of the dollies under the ATV wheels.

### DETAILED DESCRIPTION OF EXEMPLARY EMBODIMENTS

An overview of the present technology and field is described below.

### I. Snowmobile Dolly System

Snowmobile dollies are practical tools designed to simplify the task of moving snowmobiles. Snowmobiles can be heavy and unwieldy, especially in snowy conditions. These dollies are built with durability in mind, featuring wheels or casters that allow users to smoothly roll snowmobiles across various surfaces. They are adjustable to accommodate different snowmobile sizes, often equipped with protective padding to safeguard the skis. Using snowmobile dollies is straightforward; users position them under the front and rear of the snowmobile and then easily push or roll it to the desired location. These versatile devices find use in storage, transportation, and maintenance, making the process of owning and caring for snowmobiles more convenient and accessible for enthusiasts and professionals alike.

One of the core attributes of snowmobile dollies is their sturdy construction. These devices are built to withstand the weight and demands of snowmobiles, providing a stable and secure platform for transportation. Equipped with specialized wheels or casters, snowmobile dollies enable the snowmobile to be smoothly rolled or maneuvered across various surfaces, including the challenging terrains of snow and ice. Many snowmobile dollies feature an adjustable design, often incorporating telescoping arms or customizable straps. This adaptability ensures that different snowmobile sizes and shapes can be accommodated, offering a secure fit for various models. Moreover, to protect the snowmobile's sensitive skis, the present dolly system incorporates padding or rubberized surfaces that act as cushions, safeguarding the snowmobile's components during transportation.

Utilizing snowmobile dollies is a straightforward process. Users typically position the dollies beneath the front and rear of the snowmobile. Once properly placed, the snowmobile can be effortlessly rolled or pushed to its intended location, whether that's for storage, maintenance, or loading onto a trailer. By effectively distributing the weight of the snowmobile, these dollies reduce the physical strain on users and simplify the movement of these often unwieldy machines.

The versatility of snowmobile dollies extends to various settings. They are invaluable for both recreational snowmobilers and professionals, aiding in the smooth transport of snowmobiles to and from storage areas, trailers, or maintenance spaces. In addition to their role in transportation, snowmobile dollies find utility in workshops for maintenance and repair work. They allow easy access to different parts of the snowmobile, making servicing more efficient and accessible.

Multiple sizes of straps for different sized skis.

Pattern in pad allows for friction to ski in all directions. The voids in the pattern allow for water, dirt, snow, debris, and airflow to pass through preventing water damage, or rust on the snowmobile ski or snowmobile tread.

Anchors on the side of the dolly allow for easy and secure installation of the straps over the skis.

Rubber pads contact the ski sides instead of the ski keep or carbide to allow for protection of delicate pieces of the skis. Also allows for more friction so that the ski doesn't slide

Larger heavy-duty wheels with 360-degree castor allow for easy movement over all terrains. Friction stemmed castor allows for easy installation or removal of wheels from the dolly for cleaning, maintenance, repairs, etc.

Lead-in angled edges for easier loading and unloading of the ski carbide into the channel during installation.

Exemplary methods, systems, and apparatuses are disclosed below.

The present invention introduces a dolly system designed to revolutionize the transportation of skis and snowmobiles. This structural feature significantly augments the strength and durability of the dollies while maintaining their lightweight nature, rendering them exceptionally well-suited for securely transporting winter sports equipment such as skis and snowmobiles.

Beyond its exceptional strength and durability, the dolly system prioritizes user convenience. These individual dolly modules are designed for effortless transportation and maintenance. Users can easily move the dolly modules because of their lightweight but durable HDPE body.

Safety and stability during the transportation of skis and snowmobiles are paramount in our dolly system's design. The surface of each dolly module includes a specialized texture that enhances traction and prevents slippage. Moreover, the fastening straps between modules have been engineered to prevent any shifting or movement during transit, ensuring the utmost safety for both the equipment and those handling it. In some embodiments, the dolly system may be highly adaptable, tailored to meet the specific requirements of users. Modules may be customized with a variety of materials and colors to align with individual aesthetic and functional preferences.

The figures are described below. Before the embodiments are to be explained in detail, it is to be understood that the presently disclosed subject matter is not limited in application or process to the details stated, as there are other embodiments and methods of carrying out and practicing the presently disclosed subject matter than those described. As such, the language used below is not limiting and states what may be used but may not necessarily be completely exhaustive.

The base of the dolly 1000 can be equipped with different types of pads, some embodiments including the ski pads 1001 and the track pads 1002. Some embodiments may include a logo 1004 anywhere on the pads.

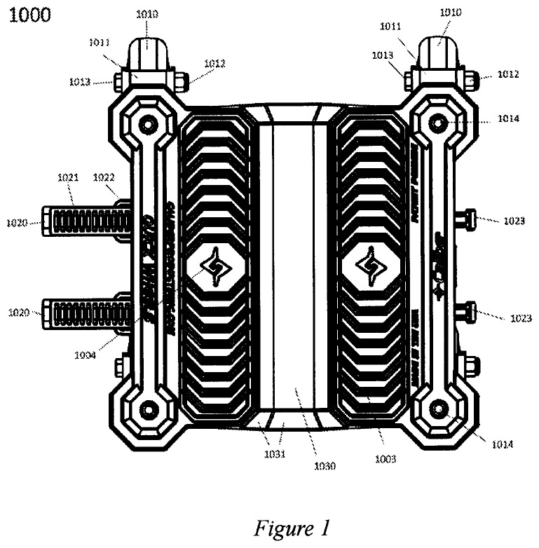

The dolly 1000 shown in FIGS. 1-5 is equipped with ski pads 1001, wheels 1010, and fastening straps 1020. The ski pads 1001 have ribs 1003 to allow for more friction against the snowmobile skis that are placed on the dolly. These also allow for air, water, and other debris to be caught when falling off the snowmobile skis. The wheels 1010 can smoothly rotate around the 360-degree swivel caster 1011 with minimal friction. The wheels 1010 are connected to the swivel caster 1011 with a nut 1012 and bolt 1013. the wheels 1010 are connected to the dolly 1000 through the wheel attachment points 1014. The dolly includes a channel 1030 to allow for a carbide 2001 and carbide blade 2002 from an attached snowmobile ski 2000 to safely and securely be secured in place without damage to the ski carbide. The “lead in angled edges” 1031 allow for the carbide to be easily moved into the channel before the ski is fastened to the dolly 1000. Embodiments allow the wheels to rotate fully around the axis parallel to the top face of the dolly base to allow the dolly to move across the floor in all directions. In some embodiments the wheel attachment points may not allow the wheels to rotate around the axis in 360 degrees.

The ski is easily fastened to the dolly 1000 by pulling the fastening straps 1020 over the ski and connecting the attachment holes 1021 (or pad attachment area) to the anchor points 1023. The anchor points 1023 may also be used to attach other accessories to the dolly 1000. The fastening strap 1020 is connected to the dolly by sliding the top of the fastening strap through the strap attachment point 1022. The bottom of the fastening strap 1024 stops the fastening strap 1020 from going through the strap attachment points 1022. The fastening strap 1020 is made of a durable yet flexible material such as rubber to allow it to be stretched over different sizes of skis. The pad attachment area does not need to include attachment holes and may include gluing, fastening, or bolting the pads directly to the pad attachment area of the dolly.

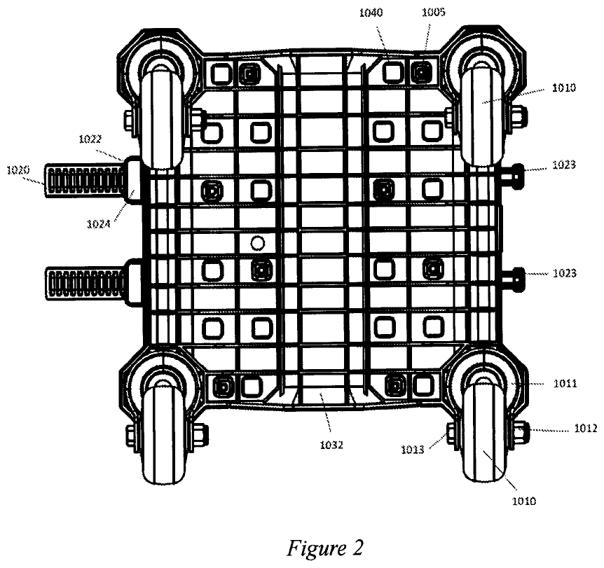

The pads 1001, 1002 are attached to the dolly 1000 by connecting the pad attachment mechanisms 1005 into the pad attachment holes 1040. FIG. 2 shows the underside of the channel 1032. Each dolly has 24 pad attachment holes 1040. Each pad attaches to the dolly 1000 at four points (pad attachment mechanisms 1005). Some embodiments include dollies with a different number of pad attachment holes 1040 or pads with a different number of pad attachment mechanisms 1005.

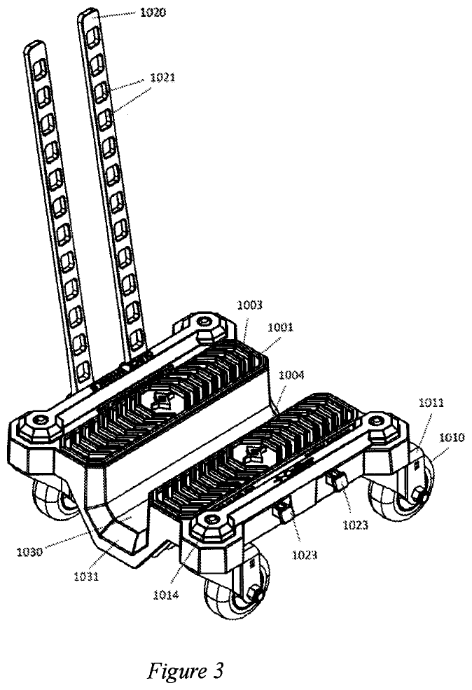

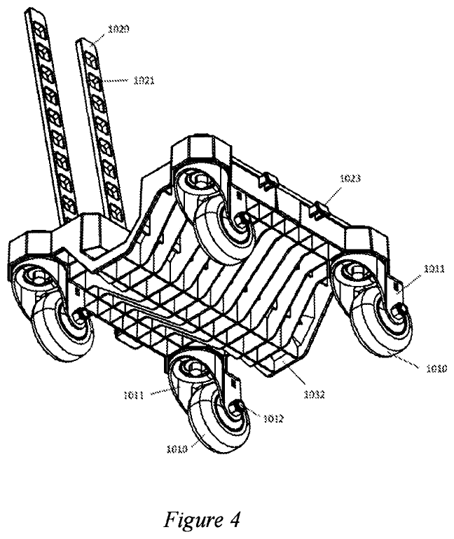

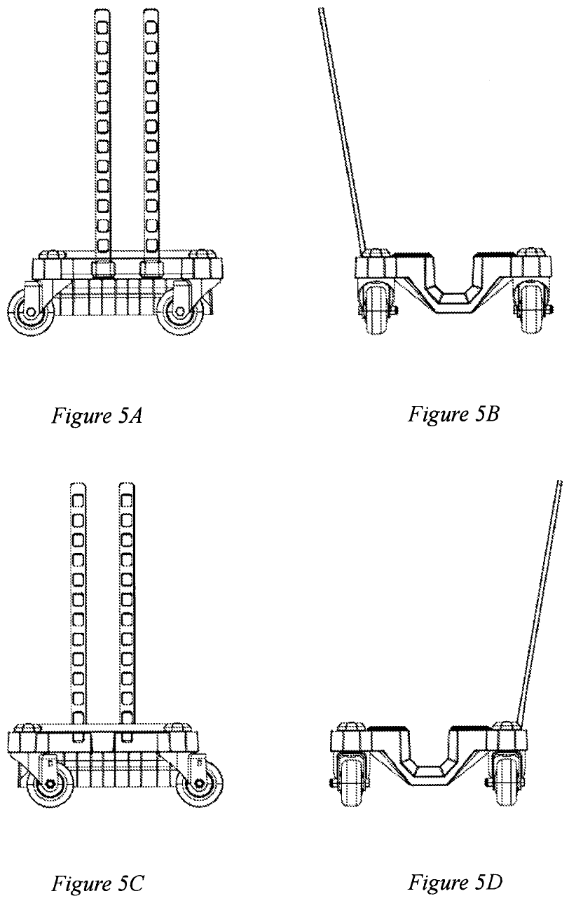

FIG. 1 shows a top view of the dolly equipped with ski pads, wheels, and fastening straps. FIG. 2 shows a bottom view of the dolly equipped with ski pads, wheels, and fastening straps. FIG. 3 shows a top perspective view of the dolly equipped with ski pads, wheels, and fastening straps. FIG. 4 shows a bottom perspective view of the dolly equipped with ski pads, wheels, and fastening straps. FIGS. 5A-5D show the dolly equipped with ski pads, wheels, and fastening straps, showcasing the left side view, front view, right side view, and rear view, respectively.

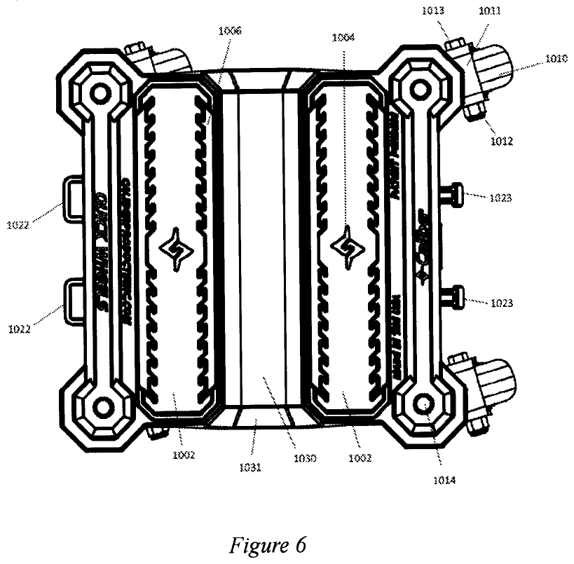

FIGS. 6-8 show the dolly 1000 equipped with the track pads 1002. The track pads 1002 include track support walls 1006 to keep the snowmobile tracks/treads in place while protecting the snowmobile and dolly from damage. The pads 1001, 1002 are made from rubber or HDPE, though any durable or flexible material could be used. The rubber helps to protect the dolly from the studs on the snowmobile tracks.

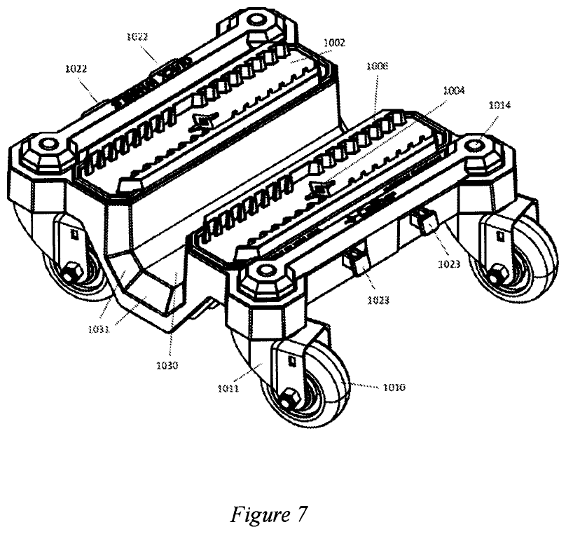

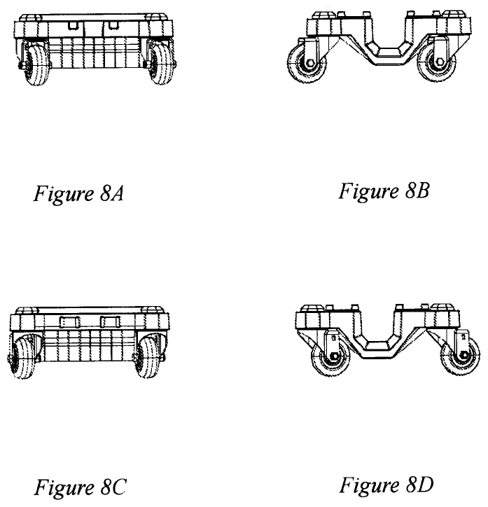

FIG. 6 shows a top view of the dolly equipped with track pads and wheels. FIG. 7 shows a top perspective view of the dolly equipped with track pads and wheels. FIG. 8 shows a top view of a dolly equipped with track pads and wheels. FIGS. 8A-8D show the dolly equipped with track pads and wheels, showcasing the right side view, rear view, left side view, and front view, respectively;

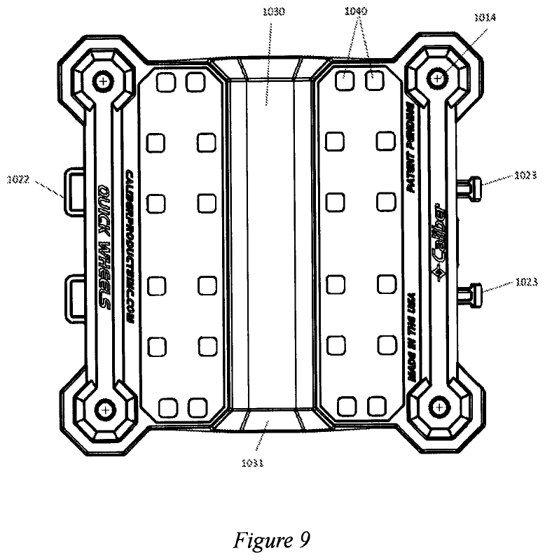

Some embodiments may include a dolly system with more or less dollies to move snowmobiles, but the standard is usually three dollies per snowmobile. FIGS. 9-13 show the base of the dolly without any pad attachments, wheels, or fastening straps attached. Snowmobile dolly systems usually include 3 dollies (2 for the skis and 1 for the tracks/tread). Other dolly systems do not include a dolly base with interchangeable attachments that allow for one to switch between a dolly designed for holding snowmobile skis and one designed to hold snowmobile tracks. These figures are depicted to highlight the dolly system's base structure and its flexibility compared to other systems lacking interchangeable pads. Additionally, this design approach lowers the manufacturing cost because only one type of base needs to be created and packaged instead of two types of bases.

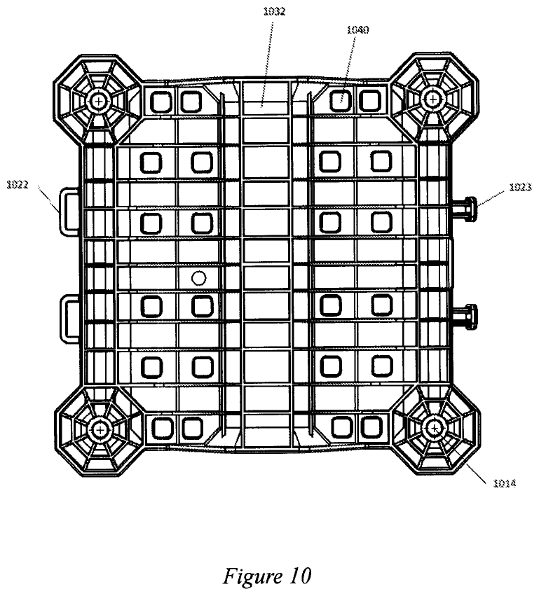

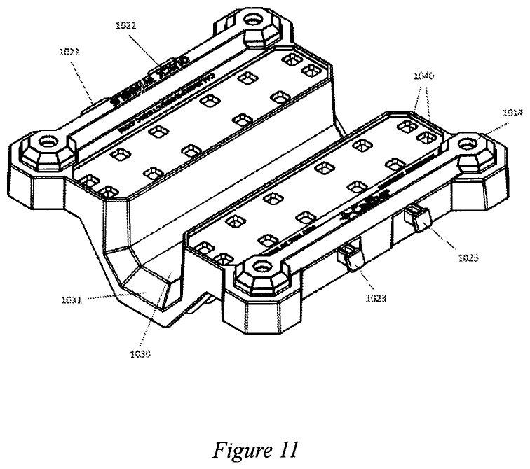

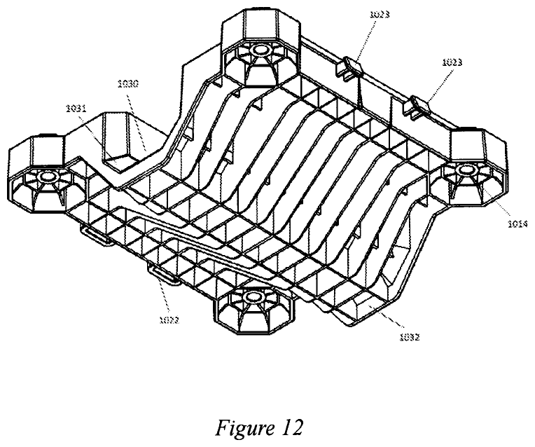

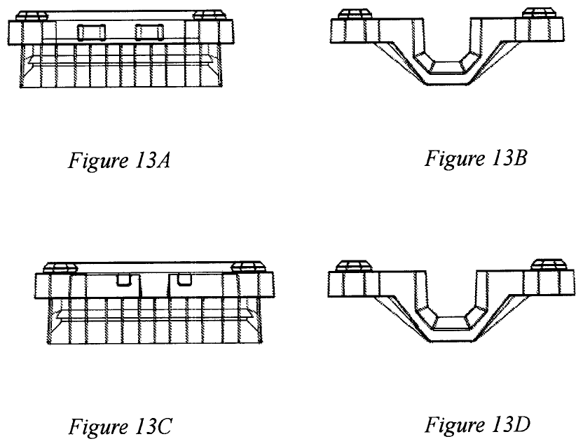

FIG. 9 shows a top view of the base of the dolly. FIG. 10 shows a bottom view of the base of the dolly. FIG. 11 shows a top perspective view of the base of the dolly. FIG. 12 shows a bottom perspective view of the base of the dolly. FIGS. 13A-13D show the base of the dolly, showcasing the left side view, front view, right side view, and rear view, respectively;

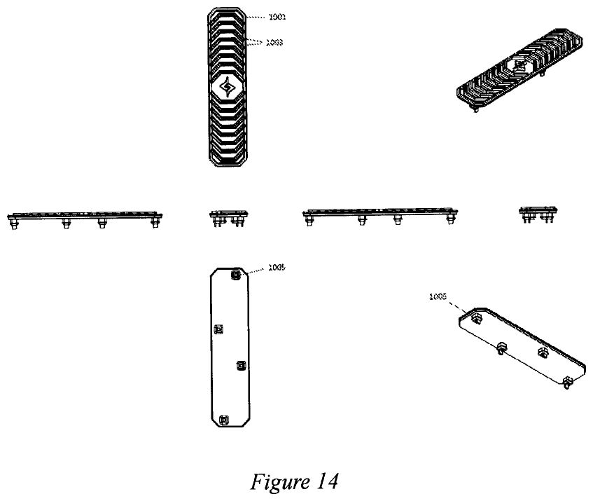

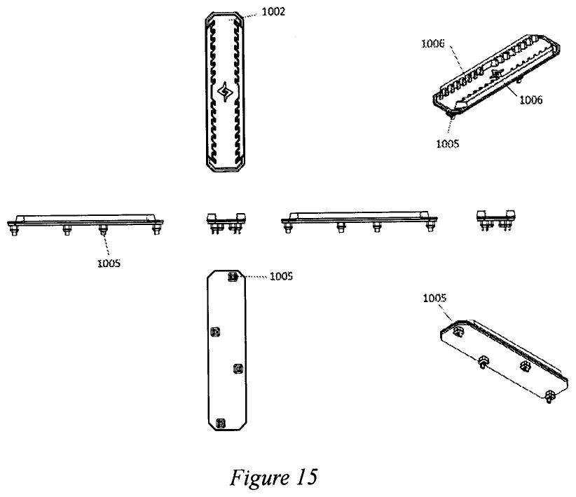

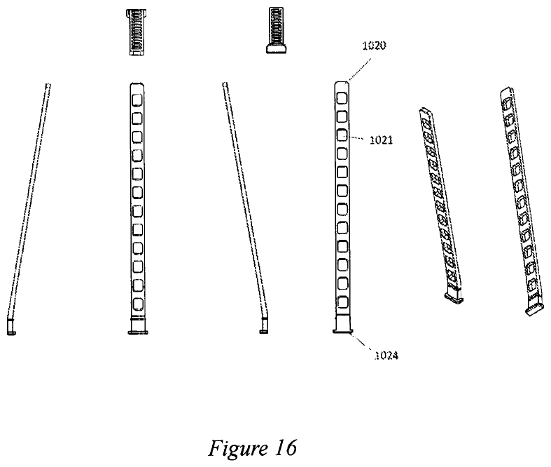

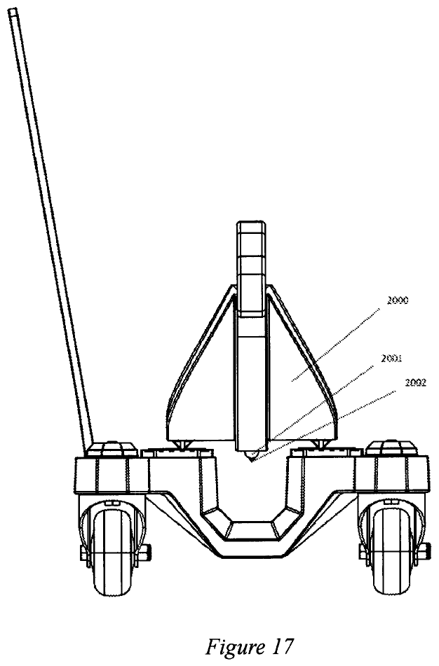

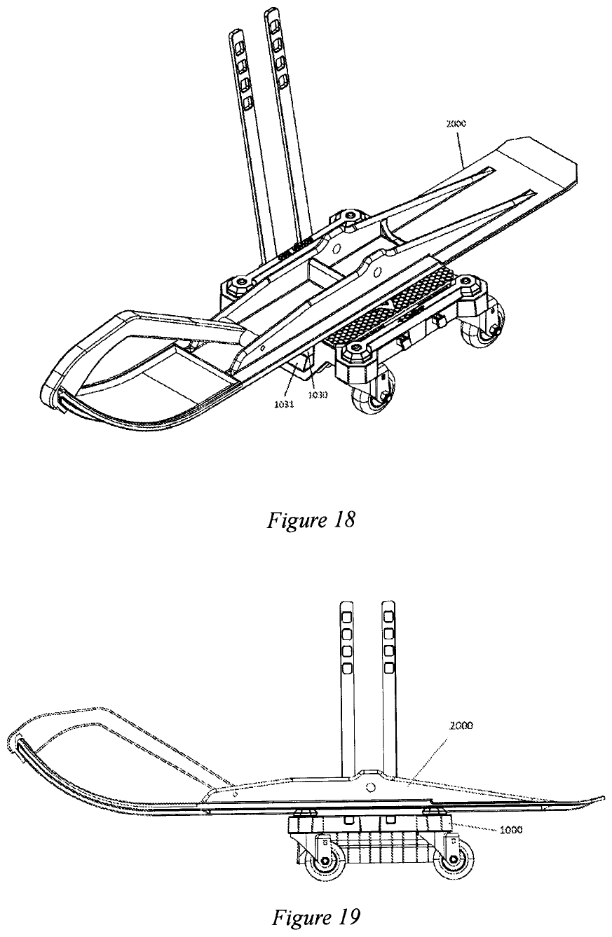

FIG. 14 shows multiple views of the ski pads. FIG. 15 shows multiple views of the track pads. FIG. 16 shows multiple views of the fastening strap.

The following embodiments may be added to the ski dolly system and are provided to offer supplementary features and information for reference.

Modular Snowmobile Dolly: Create a modular dolly system with interchangeable components. Users can easily switch between different types of wheels or tracks, depending on the terrain they plan to traverse. This allows for versatility in both deep snow and on hard-packed trails.

Remote-Controlled Dolly: Develop a snowmobile dolly system that can be controlled remotely via a smartphone app or a dedicated remote control. This feature would allow users to move their snowmobile effortlessly, even in tight spaces or when loading onto a trailer. A Remote-Controlled Dolly represents a cutting-edge innovation in the realm of snowmobile transportation, offering snowmobilers unprecedented ease and convenience in handling their vehicles. This system is designed to be operated remotely, typically through a smartphone app or a dedicated remote-control device. The primary advantage lies in its ability to eliminate the physical exertion required for moving a snowmobile manually, especially in situations where tight spaces or obstacles pose challenges. With just a few taps on a smartphone or the push of a button on a remote control, users can effortlessly steer, accelerate, and brake the dolly, directing their snowmobile precisely where they need it to go. This is particularly advantageous during loading and unloading processes, where the remote control allows for precise positioning on trailers or in storage areas. Remote-Controlled Dollies often come with customizable speed settings and precise control mechanisms, ensuring that users can handle their snowmobiles with the utmost care and precision. Additionally, some models may feature obstacle detection and collision avoidance systems, further enhancing safety and preventing accidental damage to both the snowmobile and its surroundings.

Foldable and Compact Dolly: Design a snowmobile dolly that can be folded into a compact form for easy storage and transportation. This would be especially appealing for those who have limited storage space in their garages or trailers. A Foldable and Compact Dolly is a practical and space-saving solution for snowmobile owners who value convenience and efficient storage. This innovative dolly system is designed with user-friendly foldable components that allow it to transform into a compact form when not in use, making it exceptionally easy to store and transport. One of the key advantages of this dolly is its ability to fold down to a fraction of its extended size. When not in use, the dolly can be collapsed into a compact configuration, reducing its footprint significantly. This is particularly valuable for individuals with limited storage space in their garages, sheds, or trailers, as it ensures that the dolly won't take up excess room when not in use.

The foldable design typically includes features like collapsible handles, retractable support arms, and folding wheel or track assemblies. These components are engineered to be sturdy and durable while remaining lightweight for easy handling. When it's time to transport or store the snowmobile, users can simply fold down these elements, allowing the dolly to be stowed away in a corner, hung on a wall, or placed in a small storage compartment on the snowmobile itself. Despite its compact form, this dolly maintains the strength and functionality required to support the weight of a snowmobile securely. Its foldable and compact nature also makes it a convenient travel companion for snowmobilers who frequently transport their vehicles to different riding locations. It's easy to carry and doesn't require much space in a vehicle or trailer, ensuring that it's always readily available for use.

Dolly with Built-in Heaters: Integrate a heating element into the dolly's surface to help melt snow and ice underneath the snowmobile's skis or tracks. This feature would be particularly useful for cold-weather enthusiasts, preventing ice buildup during transport.

Solar-Powered Dolly: Create an environmentally friendly snowmobile dolly system that utilizes solar panels to charge a built-in battery. This battery could power electric motors for moving the snowmobile and also provide a USB charging port for other devices while out in remote locations. The battery may also be used to connect to a system to automatically move the dolly using a power system.

Automated Loading and Unloading: Develop a dolly system with sensors and automation capabilities that can assist in loading and unloading a snowmobile onto/from a trailer. Users would simply need to align their snowmobile, and the dolly would take care of the rest. Automated Loading and Unloading could be added as a feature in the snowmobile dolly system to revolutionizes the process of getting a snowmobile onto or off a trailer or storage platform.

At its core, Automated Loading and Unloading incorporates an array of sophisticated sensors, actuators, and a control system within the dolly's design. These components work seamlessly together to execute a series of essential functions. To begin with, sensors, often including cameras or laser alignment devices, accurately detect the snowmobile's position in relation to the trailer or storage platform, ensuring precise alignment for loading or unloading. Once properly aligned, mechanical actuators or hydraulics come into play, deftly raising or lowering the dolly's platform to the perfect height, matching it with the trailer bed. This eliminates the need for strenuous manual lifting or tilting of the snowmobile, significantly reducing physical exertion. Additionally, Automated Loading and Unloading systems often incorporate secure locking mechanisms or clamps. These mechanisms ensure the snowmobile is firmly and safely fastened to the dolly, preventing any unintended movement during transport and minimizing the risk of accidents or damage.

This feature could also use the sensors during movement to alert the user if the snowmobile is about to hit an object. Users may interact with the system through an intuitive control interface, which may feature buttons, a touchscreen, or a smartphone app. With a simple push of a button or by following on-screen instructions, users can initiate the loading or unloading process. Some embodiments may automatically recognize that the loading or unloading process has begun based on a user unlatching the straps of the dolly system. The sensors may automatically turn on the alarm system once the process begins.

Augmented Reality Assistance: Some embodiments may incorporate augmented reality (AR) glasses or a smartphone app that provides step-by-step visual instructions for attaching the snowmobile to the dolly and securing it properly. This feature would be especially helpful for beginners.

Multi-Surface Dolly: Create a dolly system with adjustable suspension that can adapt to various terrains. This may include changing the size of the dolly wheels to be able to move through non-flat surfaces. Users may be able to switch between settings for soft snow, hard-packed snow, ice, bare ground, ensuring optimal stability and ease of movement.

Collision Avoidance System: Equip the dolly with sensors and a collision avoidance system to prevent accidental collisions with obstacles or other vehicles while moving the snowmobile. This safety feature would protect both the snowmobile and its surroundings. A Collision Avoidance System integrated into a snowmobile dolly is a sophisticated safety feature that employs advanced technology to prevent accidental collisions during the transport process. This system relies on a combination of sensors, software, and mechanical components to ensure the safe and damage-free movement of the snowmobile. Sensors, such as ultrasonic sensors, lidar, radar, or cameras, continuously scan the dolly's surroundings, detecting any potential obstacles, stationary or moving. The system's software processes this real-time data and makes decisions to avoid collisions. It can issue visual and audible alerts to the user, apply automatic braking mechanisms, adjust the dolly's path, or even create virtual obstacle maps for optimal navigation. This feature enhances safety during snowmobile transportation, particularly in conditions with limited visibility or when navigating tight spaces. It not only safeguards the snowmobile but also reduces the risk of damage to the dolly and its surroundings, ultimately ensuring a worry-free and secure transport experience for users.

Self-Loading Dolly: Develop a dolly system that can autonomously load and unload a snowmobile onto/from a trailer. Users would simply need to initiate the process, and the dolly would take care of the rest, making it a time-saving and user-friendly option.

Integrated Maintenance Features: Include built-in tools and compartments for basic snowmobile maintenance tasks, such as ski and track adjustments or oil changes. This would make the dolly a valuable addition to a snowmobiler's toolkit.

Load Distribution Sensors: Install load distribution sensors on the dolly's platform. These sensors can help users distribute the snowmobile's weight more evenly, reducing the risk of damaging delicate surfaces or causing unnecessary wear on tires.

Remote-Controlled Movement: Add a remote-control feature that allows users to move the dolly without physically pushing or pulling it. This remote control should offer precise speed and direction control. This also means that the dolly would need a power source of gas or electric. The battery would most likely be underneath the dolly. The battery would need to be protected by a waterproof casing to prevent melted snow from destroying the power system.

Integrated Wheel Locks: Include wheel locks or brakes on the dolly to keep it securely in place when loading or unloading the snowmobile. This feature enhances safety during the process.

Collapsible Design: Create a dolly with a collapsible design that can be easily stored in a snowmobile's storage compartment when not in use. This ensures it's readily available whenever needed.

Accessory Attachment Points: Provide attachment points on the dolly for accessories like tie-down straps or cargo baskets, allowing users to transport additional gear or equipment alongside their snowmobile.

Handles: Some embodiments may include a dolly system with handles on one or more of the dollies. The handles may also be retractable/telescoping/foldable for easy storage and transportation. Users can fold down the handles when not in use, making it a compact and space-saving solution.

Adjustable Ground Clearance: Design a snowmobile dolly with adjustable ground clearance. Users can easily raise or lower the dolly's platform to accommodate different surface conditions, ensuring it won't damage sensitive or uneven surfaces. This would allow for the snowmobile to not hit different surfaces that are low to the ground and clear surfaces by allowing the snowmobile to be placed higher than the object blocking the way. This may be possible using telescoping legs on the dolly system.

Quick-Release Hitch: Design a quick-release hitch system that securely attaches the snowmobile to the dolly with minimal effort. This feature simplifies the loading and unloading process, reducing the risk of accidents or damage. The snowmobile may be pulled off the dolly quickly if needed to prevent accidents.

Shock-Absorbing Suspension: Integrate a shock-absorbing suspension system into the dolly's wheels or tracks to cushion vibrations and impacts during transport, reducing stress on the snowmobile's frame. This is possible because of the HDPE. Metal does not allow for increased shock absorption.

Integrated Lighting: Add LED lighting to the dolly for increased visibility when loading and unloading in low-light conditions, improving safety and preventing accidental damage.

Some embodiments may include the use of swivel casters. Equip the dolly with swivel casters on the wheels or tracks to enable easier maneuverability, especially when navigating tight corners or narrow spaces. Swivel casters are pivotal components in a snowmobile dolly system, enhancing its maneuverability and versatility. These wheel mechanisms rotate 360 degrees, providing several advantages. First and foremost, swivel casters greatly improve the turning radius of the dolly, allowing it to navigate tight spaces with ease, such as cramped garages or trailers. Their ability to move in any direction facilitates quick and effortless changes in direction, making it simple for users to align the snowmobile for loading onto a trailer or positioning it precisely in a storage area. Moreover, swivel casters reduce the effort required for steering, even when the dolly is carrying a heavy snowmobile. Users can easily push or pull the dolly in their desired direction, minimizing physical strain. This versatile movement capability allows the dolly to move in any direction, including forward, backward, left, and right, ensuring precise control during positioning and transport. Importantly, swivel casters contribute to a smoother and more stable ride for the snowmobile, reducing the risk of accidental bumps or surface damage during movement. Some may include locks to lock the wheels in place.

The present invention introduces a forward-thinking dolly system meticulously designed to enhance the transportation of skis and snowmobiles while prioritizing ski safety, reducing the risk of damage, and ensuring user convenience. This innovative dolly system incorporates specialized rubber pads with integrated channels, promoting airflow and delivering several significant benefits for the transport of winter sports equipment.

One of the dolly system's defining features is the specially engineered pattern of channels within the dolly's padding. This pattern is designed to provide exceptional ski friction in all directions. It serves as a secure anchor for the skis, preventing any unwanted slippage during transportation. This enhanced ski friction minimizes the risk of accidental impacts, scratches, or damage to the ski's surface, ultimately safeguarding this valuable equipment. The padding may be made of HDPE or rubber. Other materials would also be possible.

The pattern within the dolly's padding also incorporates strategically placed channels/voids. These elements act as efficient drainage mechanisms, allowing water, snow, and any other debris to quickly and effortlessly fall off the ski during transport. This design prevents the accumulation of moisture, which can lead to corrosion or deterioration of the ski's material over time. By facilitating efficient water drainage, the dolly system ensures the long-term preservation of the ski.

In addition to its water drainage capabilities, the specialized pattern plays a vital role in promoting airflow between the ski and the dolly's surface. It aids in the rapid drying of the ski's underside, preventing moisture-related issues such as rust or weakening of bindings. These channels also allow for dirt, snow, and water to fall off of the ski into these channels. The channels are easily cleaned, and in some embodiments, the channels may be integrated into a tray. This tray is easily removed so that the channels may be cleaned in the sink, washer or dishwasher.

### II. Pontoon Boat Dolly System (And Other Embodiments)

Some embodiments of the present invention include multiple types of removable and replaceable pads. Some embodiments include rubber pads with a curved ramp-like shape (curved pads). This allows for the dollies to hold the float tubes on a pontoon. This curved shape also allows the dollies to hold vehicles with wheels in place during transportation.

Some embodiments include using the snowmobile dolly system for marine pontoons. The pontoon boat may comprise a durable frame constructed from materials such as steel or aluminum to withstand the weight of pontoon boats. It may feature adjustable components such as telescoping arms or customizable straps to accommodate pontoon boats of different sizes and shapes.

In some embodiments, protective padding or rubberized surfaces are incorporated to prevent scratches and damage to the pontoons during transportation. Large wheels equipped with 360-degree castors ensure smooth movement across various terrains, while removable wheels facilitate easy cleaning and maintenance. In a preferred embodiment, the rubber pads are a curved ramp-like shape on opposite sides of the top of each dolly. This allows for the dollies to hold the float tubes on the pontoon.

In some embodiments, there may be a dolly positioned on each of the float tubes of the pontoon. In some embodiments there may be more than one dolly positioned on each float tube, one near the nose cone, and one near the end cap to support the pontoon in both the front and the back. In some embodiments, the middle float tube of a 3-tube pontoon may not need a dolly supporting it during transportation. Some embodiments may not require anchor points or strap connection points.

Anchors positioned on the dolly system allow for secure fastening of pontoon boats using straps made of durable yet flexible material. Additionally, adjustable suspension or telescoping legs enable users to adapt the dolly's height to different surface conditions for stability and surface protection.

The present invention pertains to a versatile and innovative dolly system, potentially designed for the efficient transportation of wheeled vehicles and marine pontoons, incorporating removable pads that may securely hold pontoons in place. This dolly system may include several key features aimed at enhancing durability, ease of use, and adaptability, making it a potentially ideal solution for various transportation needs.

In some embodiments, the dolly system may comprise individual dolly modules, each equipped with a lightweight yet robust body. The body may be constructed from materials such as high-density polyethylene (HDPE), potentially providing exceptional strength and longevity while remaining manageable for users to transport and maintain. These modules may be designed with specialized textures on their surfaces to enhance traction and prevent slippage, thereby ensuring that the equipment remains securely in place during transit.

A distinguishing feature of this dolly system may include removable rubber pads. These pads could be designed to fit securely onto the dolly base, offering a stable and cushioned surface for holding pontoons. Each dolly base may feature multiple pad attachment areas, allowing for easy installation and removal of the pads. This modular design could enable users to customize their dolly setup according to specific requirements, whether they are transporting pontoons, wheeled vehicles, or other large items.

The rubber pads may be engineered with a unique pattern that provides multidirectional friction, potentially preventing the pontoons from shifting during transport. The pattern might also include voids that facilitate the drainage of water, dirt, snow, and other debris, thereby preventing damage or rusting of the pontoons. Additionally, these pads may feature lead-in angled edges, making it easier to load and unload pontoons or other equipment onto the dolly.

Each dolly base might be equipped with multiple wheel attachment points, allowing for the installation of wheels and swivel casters. These wheels could be designed to rotate smoothly around a 360-degree axis, providing excellent maneuverability across various terrains. The use of friction stemmed casters may allow for easy installation and removal of the wheels, making maintenance and cleaning straightforward.

To further enhance stability, the dolly system may include fastening straps that securely anchor the pontoons to the dolly bases. These straps might be made from durable, flexible materials such as rubber, ensuring a tight fit over different sizes of pontoons. The straps could be connected to the dolly base via strap attachment points, which might be strategically positioned to distribute the load evenly and prevent movement during transit.

The modularity of the dolly system may extend to its adaptability for different types of equipment. In addition to transporting pontoons, the dolly system might be configured to move wheeled vehicles such as motorcycles, ATVs, and personal watercraft. This could be achieved by simply changing the type of pads attached to the dolly base. For instance, curved pads might be used to accommodate the float tubes of a pontoon, while flat pads could be used for vehicles with wheels.

The versatility of this dolly system may be further demonstrated by its potential applications in various industries. It might be utilized in manufacturing, fabrication, and construction to assist in the transportation of raw materials. It could also serve as a mechanic's creeper, allowing individuals to perform maintenance work underneath vehicles with ease. Moreover, the dolly system might be capable of transporting large objects such as furniture, barrels, and bins, making it a valuable tool for a wide range of tasks.

In some embodiments, the dolly system may include additional features to enhance user convenience and functionality. For example, integrated maintenance features such as built-in tools and compartments for basic tasks like ski and track adjustments or oil changes might be included. This could make the dolly system a comprehensive solution for both transportation and maintenance needs.

To ensure the highest level of safety and stability, the dolly system may also incorporate advanced features such as load distribution sensors, shock-absorbing suspension systems, and collision avoidance mechanisms. These enhancements might provide users with real-time feedback and control, reducing the risk of accidents and ensuring the safe transport of valuable equipment.

The dolly system may also be suitable for wheeled vehicles with two or more wheels, such as motorcycles, ATVs, ORVs, and utility vehicles like Side x Side. The system's modular design allows for the pads to be adjusted or replaced to fit various wheel configurations. This flexibility makes it possible to transport different types of wheeled vehicles safely and efficiently without the need for multiple transport solutions.

For snow machines consisting of one ski and a track, such as snow bikes, the dolly system may be adapted to accommodate these specific needs. The specialized rubber pads can be configured to hold the ski and track securely, ensuring that the snow machine remains stable during transportation. This feature is particularly useful for transporting snow machines over surfaces where they cannot be driven directly.

The dolly system may be employed for transporting personal watercrafts like jet skis. By adjusting the pad configurations, the dolly can be tailored to fit the hull of a jet ski, providing a stable platform for moving the watercraft. This application is ideal for users who need to transport jet skis to and from the water or between storage locations.

In manufacturing, fabrication, and construction, the dolly system can assist in the transportation of raw materials. The sturdy design and adaptable pad configurations make it possible to move heavy and bulky materials safely and efficiently. This application enhances productivity and reduces the physical strain on workers, making it an invaluable tool in industrial settings.

The dolly system may also be used by humans to assist in mechanical work underneath vehicles or machines, functioning as a mechanic's creeper. The low-profile design and ease of maneuverability allow users to position themselves comfortably under vehicles for maintenance and repairs. The durable construction ensures that the dolly can support the weight of both the user and their tools.

In some embodiments, the dolly system can be employed to transport large objects such as furniture, barrels, and bins. The adaptable pad configurations and robust construction make it possible to move these items safely and securely. The removable pads on the dolly system may allow for the addition of differently shaped pads, specifically designed to move irregularly shaped objects securely and efficiently. This feature enhances the dolly system's versatility, enabling it to adapt to a wide variety of transportation needs. By swapping out the pads, users can customize the dolly to fit the unique contours and dimensions of various objects, ensuring a stable and secure transport solution regardless of the object's shape or size.

In some embodiments, the dolly system can be equipped with curved pads that fit the rounded contours of pontoon float tubes. For wheeled vehicles like motorcycles and ATVs, curved or specially contoured pads can be used to securely hold the wheels in place. The adaptability of the removable pads makes it possible to configure the dolly system for different types of equipment, ensuring that each item is transported safely and efficiently without the risk of shifting or damage. For snowmobiles, ribbed/flat pads may be used to secure the snowmobile to the dolly system.

The dolly system's innovative design includes removable pads that can be turned 90 degrees, providing enhanced versatility for transporting both pontoons and wheeled vehicles. When configured for pontoons, the dolly pads are typically oriented to cradle the curved bottom of the pontoons. This orientation ensures a snug fit, distributing the weight evenly and preventing the pontoons from shifting during transit. The pads' contoured shape aligns perfectly with the pontoon's float tubes, and the use of multiple dollies under each tube provides balanced support and stability, even on uneven surfaces.

When reoriented for wheeled vehicles, the dolly pads can be turned 90 degrees to accommodate the shape and size of the vehicle's tires. This orientation allows the pads to cradle the wheels securely, preventing lateral movement and ensuring that the vehicle remains stable during transport. The dollies' modular design allows each wheel to be placed on individual dollies, enhancing maneuverability. The swivel casters enable smooth movement in any direction, making it easy to position the vehicle precisely where needed.

This dual-orientation capability of the dolly system's pads significantly enhances its versatility, allowing it to handle a wide range of transportation needs. Whether supporting the rounded bottom of pontoons or the wheels of various vehicles, the dolly system provides a stable, secure, and adaptable solution. The ability to quickly and easily reconfigure the pads ensures that users can efficiently switch between different types of loads, making the dolly system an invaluable tool for diverse transport applications.

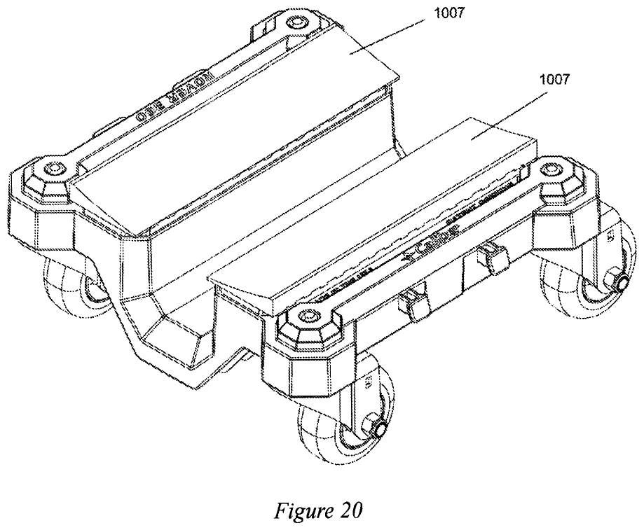

FIG. 20 depicts an embodiment of the dolly system with removable angled pads 1007 designed to secure a variety of objects to the dolly using friction. The dolly is equipped with four swivel casters, enhancing maneuverability. The top view shows the modular design, allowing for the attachment of differently shaped pads to accommodate various transportation needs.

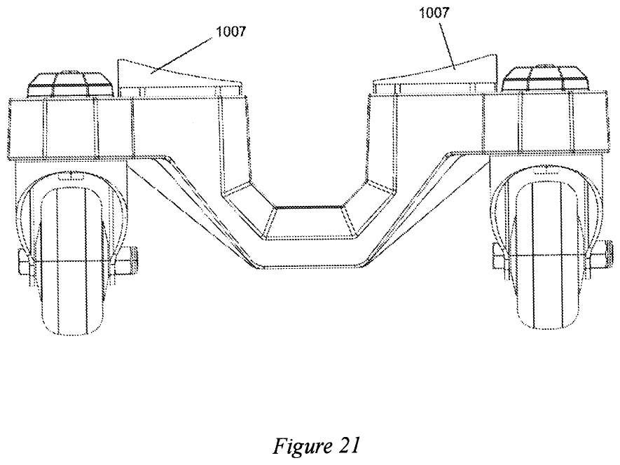

FIG. 21 depicts a side view of the dolly system, highlighting the central channel that helps stabilize cylindrical objects. This view demonstrates the system's capacity to adapt to irregularly shaped items, ensuring secure transportation.

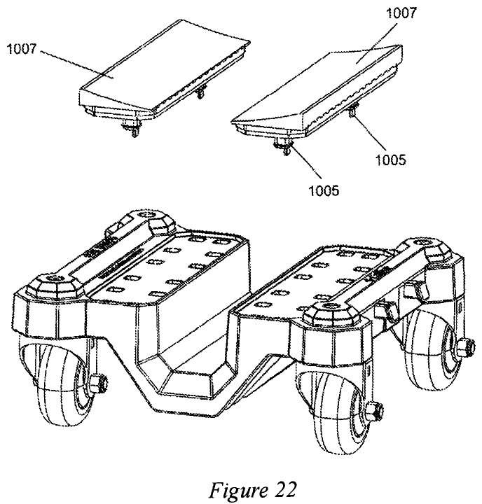

FIG. 22 depicts the dolly system with the removable angled pads 1007 detached. This exploded view emphasizes the modular nature of the design, showcasing how the pads can be easily interchanged to fit specific requirements for different objects.

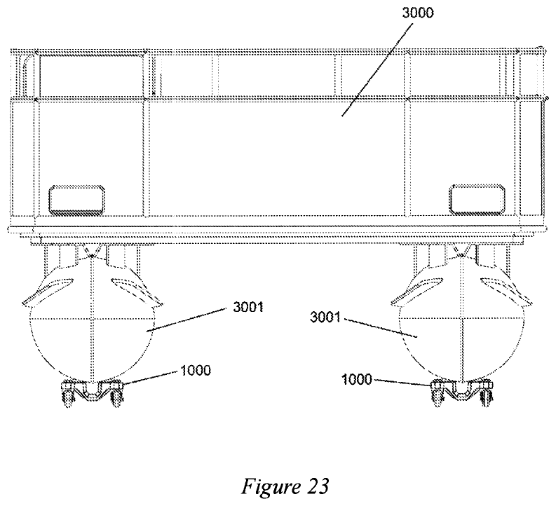

FIG. 23 depicts an embodiment where the dolly system 1000 is used to transport a pontoon 3001. The dolly's angled pads are shaped to cradle the rounded bottom of the pontoon 3001, ensuring stability and preventing movement during transport. The pontoon boat 3000 is connected to the pontoons 3001.

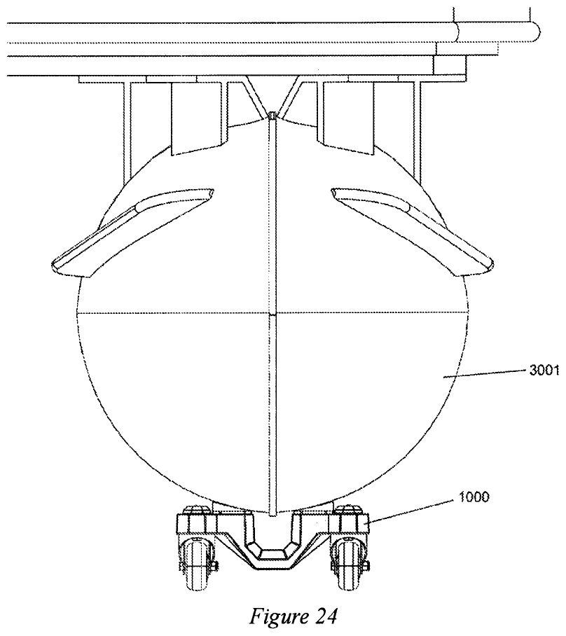

FIG. 24 depicts a perspective view of the pontoon dolly system in action. Multiple dollies are placed under the pontoon, each with pads shaped to fit the contours of the pontoons, illustrating the versatility of the system in handling large and irregularly shaped marine vehicles.

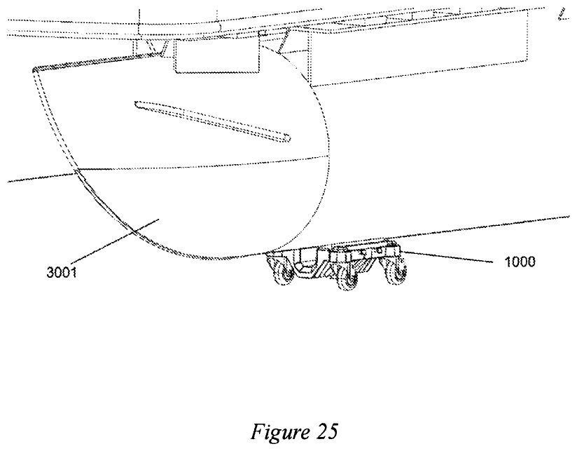

FIG. 25 depicts a rear view of the pontoon supported by the dolly system, demonstrating the secure fit of the pads around the pontoon's float tubes. This view highlights the system's ability to distribute weight evenly, preventing damage during transportation.

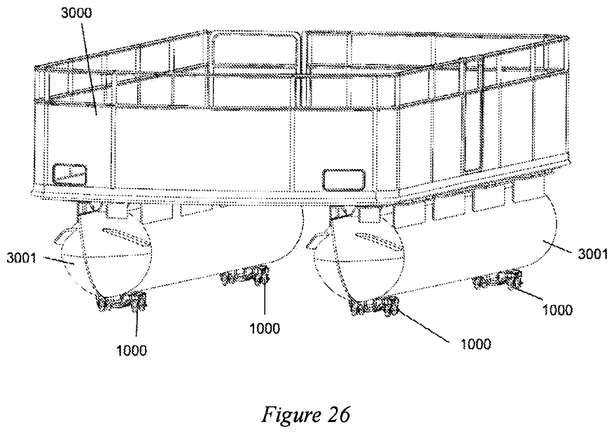

FIG. 26 depicts the dolly system used in a full pontoon setup, showing multiple dollies in place. This configuration underscores the modularity and scalability of the system, which can be adjusted based on the size and shape of the object being transported, making it suitable for a wide range of applications.

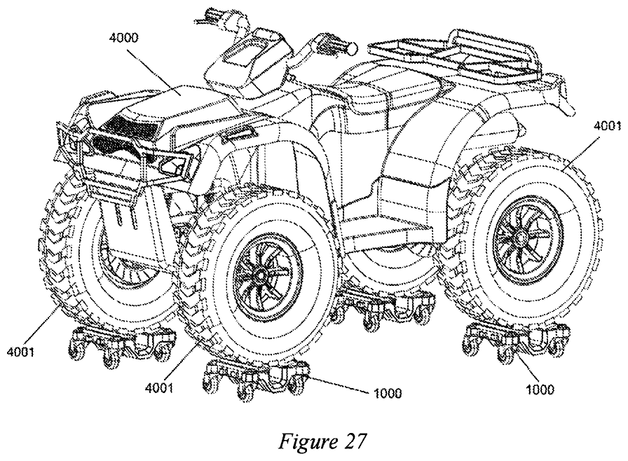

FIG. 27 depicts an embodiment of the dolly system used with an ATV. The figure shows the ATV securely positioned on the dolly system, highlighting the use of multiple dollies under each wheel to provide stable support and facilitate movement.

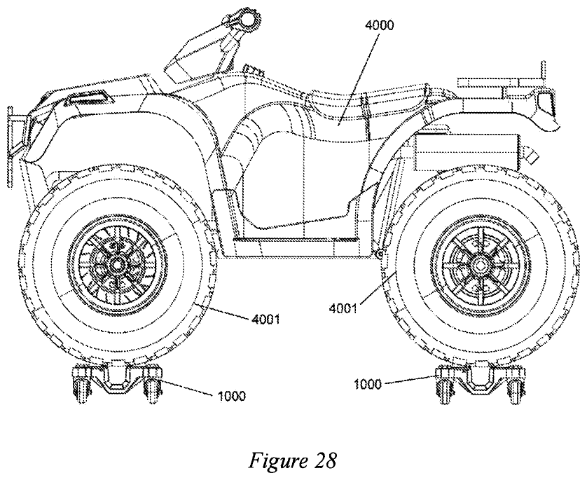

FIG. 28 depicts a side view of an ATV (wheeled vehicle 4000) on a dolly 1000. This perspective emphasizes the alignment of the dollies with the ATV wheels (vehicle wheel 4001), showcasing how the removable pads conform to the wheel shapes to ensure a secure fit during transportation. This orientation is shown to be turned 90 degrees with respect to the dolly orientation used for pontoons. In this example the same type of angled pads are used as when using the dolly for pontoons, but some embodiments may include a different angle or pad type used to secure the wheeled vehicle the dolly system. Some embodiments may include the use of the straps to fasted the wheels of the vehicle to the dolly.

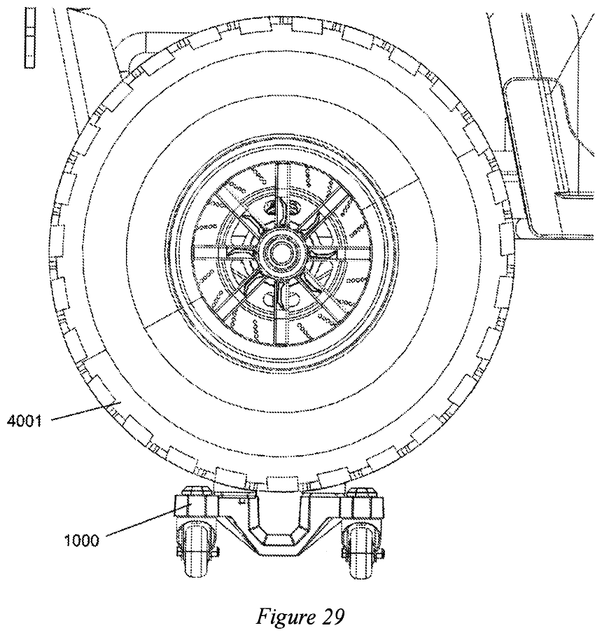

FIG. 29 depicts a detailed view of the rear wheel of the wheeled vehicle 4000 resting on the dolly system. This close-up view highlights the interaction between the dolly and the vehicle wheel 4001, demonstrating the pad's capability to cradle the wheel securely.

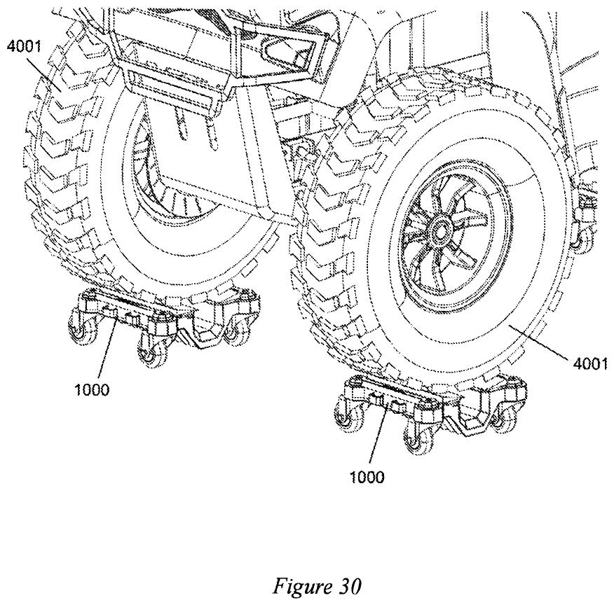

FIG. 30 depicts a perspective view of the front wheels of the ATV on the dolly system. This angle illustrates how the dollies are positioned to support the weight of the ATV, ensuring stability and ease of movement across different surfaces.

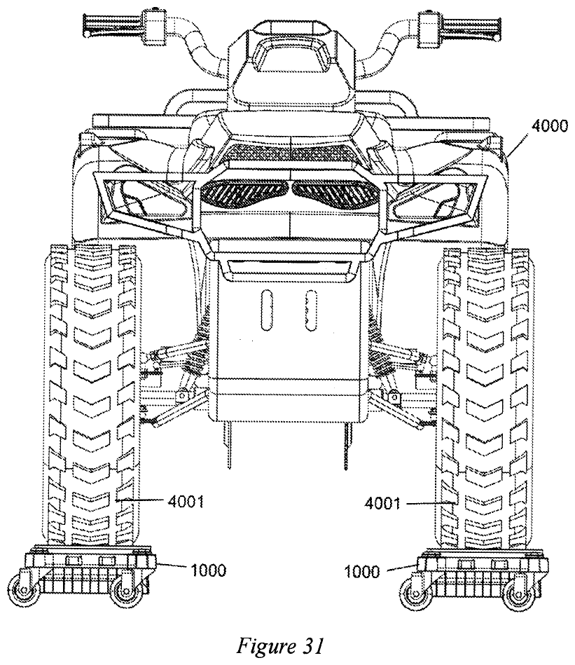

FIG. 31 depicts a front view of the ATV on the dolly system. This view clearly shows the alignment and positioning of the dollies under the ATV wheels, emphasizing the system's ability to provide balanced support and facilitate transportation.

What is claimed is:

1. A multi-purpose dolly system with at least one dolly for transporting an object, the multi-purpose dolly system comprising:
at least one dolly;
an object that is being transported; and
at least one detachable pad;
the dolly comprising:
a dolly base;
at least three wheel attachment points wherein each attachment point is connected to a wheel capable of rotating around an axis; and
at least one pad attachment area, wherein the pad attachment area is configured to be in communication with the at least one detachable pad;
wherein the detachable pad is configured to securely hold the object in place while the object is being transported.

2. The multi-purpose dolly system of claim 1, wherein the object is a vehicle.

3. The multi-purpose dolly system of claim 2, wherein the vehicle is one of a pontoon, motorcycle, ATV, and personal watercraft, wheeled vehicle, jet ski, or snowmobile.

4. The multi-purpose dolly system of claim 2, wherein the object is one of a human, a piece of furniture, a barrel, or a bin.

5. The multi-purpose dolly system of claim 1, wherein the dolly base includes an anchor point that can connect to an accessory.

6. The multi-purpose dolly system of claim 5, wherein the accessory is one of a tie-down strap, cargo basket, or an equipment.

7. The multi-purpose dolly system of claim 1, wherein the detachable pad is made of a flexible material.

8. The multi-purpose dolly system of claim 7, wherein the flexible material is rubber, HDPE, or an HDPE blend.

9. The multi-purpose dolly system of claim 1, wherein the detachable pad may be removed from the pad attachment area without the use of an external tool.

10. A multi-purpose dolly system with at least one dolly for transporting an object, the multi-purpose dolly system comprising:
at least one dolly;
an object that is being transported;
a first detachable pad; and
a second detachable pad;
the dolly comprising:
a dolly base;
at least three wheel attachment points wherein each attachment point is connected to a wheel capable of rotating around an axis;
a first pad attachment area, wherein the first pad attachment area is configured to be in communication with the first detachable pad; and
a second pad attachment area, wherein the second pad attachment area is configured to be in communication with the second detachable pad;
wherein the first detachable pad and the second detachable pad are configured to securely hold the object in place while the object is being transported.

11. The multi-purpose dolly system of claim 10, wherein the first detachable pad and the second detachable pad are configured to securely hold the object in place while the object is being transported.

12. The multi-purpose dolly system of claim 10, wherein the first detachable pad and the second detachable pad are made of a flexible material.

13. The multi-purpose dolly system of claim 12, wherein the flexible material is rubber, HDPE, or an HDPE blend.

14. A multi-purpose dolly system with at least one dolly, the multi-purpose dolly system comprising:
at least one dolly;
a first detachable pad having a first shape; and
a second detachable pad having a second shape
the dolly comprising:
a dolly base;
at least one wheel attachment point wherein the wheel attachment point is connected to a wheel; and
at least one pad attachment area with at least one pad attachment point, wherein the pad attachment area is configured to be in communication with the first detachable pad having a first shape;
wherein the pad attachment area is configured to be able to detach the first detachable pad and replace the first detachable pad with the second detachable pad;

15. The multi-purpose dolly system of claim 14, wherein the first shape and the second shape are different.

16. The multi-purpose dolly system of claim 15, wherein the first shape is configured to conform to a first object and the second shape is configured to conform to a second object.

17. The multi-purpose dolly system of claim 14, wherein the first object is a vehicle.

18. The multi-purpose dolly system of claim 17, wherein the vehicle is one of a pontoon or wheeled vehicle.

19. The multi-purpose dolly system of claim 1, wherein the dolly base includes an anchor point that can connect to an accessory.

20. The multi-purpose dolly system of claim 19, wherein the accessory is one of a tie-down strap, cargo basket, or an equipment.
